(19) United States
(12) Patent Application Publication
(10) Pub. No.: US 2012/0094589 A1
(43) Pub. Date: Apr. 19, 2012

(54) AIR DEFLECTOR AND METHOD FOR MOUNTING AN AIR DEFLECTOR

(75) Inventors: Ralf Knoch, Karlsruhe (DE); Dirk Kröplin, Karlsruhe (DE); Daniel Metz, Karlsdorf-Neuthard (DE); Volkmar Uebele, Bad Nauheim (DE)

(73) Assignee: BSH Bosch und Siemens Hausgerate GmbH, Munich (DE)

(21) Appl. No.: 12/992,302

(22) PCT Filed: May 4, 2009
(86) PCT No.: PCT/EP2009/055349

§ 371 Date: Aug. 12, 2011

(30) Foreign Application Priority Data
May 13, 2008 (DE) 10 2008 023 311.0

(51) Int. Cl. B08B 15/02; B23P 11/00; F24F 7/00

(52) U.S. Cl. 454/66; 29/428

(57) ABSTRACT

An air deflector of an extractor hood, wherein the air deflector has two components to divert air, which is extracted from a chamber by the extractor hood back into the chamber. The air deflector also has a plug connector to connect the two components to each other in a detachable or non-detachable manner.

### TECHNICAL FIELD

The present invention relates to an air deflector in accordance with the preamble of claim 1 and also to a method for mounting an air deflector in accordance with the preamble of claim 13.

### PRIOR ART

Air deflectors are used to deflect the air extracted from a chamber and filtered by an extractor hood (fat filter and/or odor filter) from the air extraction duct of the extractor hood back into the chamber. In such cases, as is known from publications DE 101 18 881 A1, EP 1 843 100 A2 and DE 200 05 154 U1 for example, the air flow can be divided up by an air deflector and diverted by around 90 degrees in two different directions.

Air deflectors known from the prior art are made from two substantially identical parts screwed together. Screwing the parts together allows dissimilarities of the respective components to be compensated for during assembly. However screwing the parts together demands a comparatively large amount of time during assembly or mounting of the air deflector.

For wall mounting conventional air deflectors, as are shown for example in FIGS. 14 and 15 of publication DE 101 18 881 A1, are screwed to the wall via their rear panel and where necessary two further attachment plates to an attachment bracket of the air deflector or of the inner duct of the air deflector. In such cases the width of the air deflector is predetermined by its construction. Different widths of air defector are thus used for air extraction ducts of different widths.

### PRESENTATION OF THE INVENTION

### Problem, Solution, Advantages

Using as its starting point the disadvantages and shortcomings set down above, as well as taking due account of the outlined prior art, the underlying object of the present invention is to develop a deflector plate of the type described above so that the components of the defector plate can be assembled easily and rapidly. To facilitate the mounting of the deflector plate the plate should be constructed from as few individual components as possible.

This object is achieved by a deflector plate with the features specified in claim 1 and by a method with the features specified in claim 13. Advantageous embodiments and useful developments of the present invention are identified in the respective subclaims.

The present invention is thus based on the idea that the deflector plate can be constructed from two components by plugging them into each other and optionally by latching them. To this end the preferably identical components are able to be joined by at least one plug connection in a detachable or non-detachable manner. By comparison with conventional deflector plates, this makes a reduction in parts and simpler and faster mounting possible.

In accordance with an advantageous embodiment of the present invention the components of the deflector plate, for diverting the air extracted by the extractor hood, for example from a wall hood or island hood embodied for recirculating air operation, have at least one first and at least one second deflector element in each case, as well as if necessary at least one further deflector element. The deflector elements are arranged in relation to each other such that a deflector channel for diverting at least a part of the air extracted by the extractor hood back into the chamber is formed in the space between two deflector elements.

To keep the number of individual parts of the air deflector as small as possible, the first and/or the second deflector element and/or the further deflector element are preferably embodied in one piece with the respective component of the air deflector. In this case at least one plastic is preferably used for manufacturing the first and/or the second and/or the further deflector element.

The person skilled in the art will especially appreciate an exemplary embodiment of the present invention which, to create a simple variation in the width of the air deflector, has at least one auxiliary element able to be connected with the air deflector, for example at least one additional component able to be plugged into the air deflector. This auxiliary element, preferably embodied in one piece, enables the air deflector to be mounted in a simple manner in different widths of exhaust air duct. In this case the auxiliary element preferably directly adjoins in its usage position the air outlets of the components of the air deflector connected to each other and the air outlets of the exhaust air duct of the extractor hood.

The attachment of the air deflector to the exhaust air duct of the extractor hood can be achieved simply and quickly by means of a retaining element to suspend, attach or plug in the air defector on or from a mounting bracket able to be arranged on the exhaust air duct. This exhaust air duct can be assigned to a wall hood or an island hood for example.

In the wall hood embodiment the mounting bracket is preferably embodied to both accept the air deflector and to attach the exhaust air duct to the wall. In this case a desired distance between the air deflector and the wall can be created using the shape of the mounting bracket and/or via at least one spacer arranged on the air deflector.

The present invention thus further relates to a mounting system for attaching an air deflector
to a wall, for example in an exhaust air duct of a wall cooker hood, or
to an extractor hood arranged in an island range, for example in an exhaust air duct of an island cooker hood,

which mounting system features an air deflector of the type described here and a mounting bracket of the type described here.

The present invention finally relates to the use of an air deflector in accordance with the type described here for an air extractor hood embodied for exhaust air or exhaust air and recirculating air operation, for example for an wall cooker hood or island cooker hood.

### BRIEF DESCRIPTION OF THE DRAWINGS

As already explained above, there are different possibilities of arranging and developing the teaching of the present invention in an advantageous manner. In this context the reader is referred on the one hand to the claims subordinate to claim 1 as well as to claim 13, on the other hand, further embodiments, features and advantages of the present invention are explained below in greater detail with reference to aspects such as the exemplary embodiment illustrated in FIGS. 1 to 9.

The figures show:

FIG. 1 a perspective view of a part of an exemplary embodiment of an air deflector in accordance with the present invention which is mounted in accordance with the method of the present invention in an exhaust air duct of an extractor hood, namely a detailed view of a first component of the air deflector;

FIG. 2 a perspective diagram of a view of the air deflector from FIG. 1 assembled from a first component and a further component;

FIG. 3 a perspective diagram of a detailed view of an auxiliary element of the air deflector from FIG. 1;

FIG. 4 a perspective diagram of a view of the air deflector from FIG. 1 assembled from the first component, the further component and two auxiliary elements;

FIG. 5 a perspective diagram of a detailed view of an exhaust air duct with mounting bracket able to be attached to a wall, on which the air deflector from FIG. 1 is able to be disposed;

FIG. 6 a perspective diagram of the air deflector from FIG. 1 mounted in the exhaust air duct from FIG. 5;

FIG. 7 a perspective diagram of a detailed view of an exhaust air duct able to be attached to a ceiling, namely a chimney with a telescopic stabilization tower in which the air deflector from FIG. 1 is arranged;

FIG. 8 a perspective diagram of the telescopic chimney with tower from FIG. 7 in the closed or assembled form; and

FIG. 9 a schematic diagram of an exemplary embodiment of an extractor hood, namely a wall cooker hood, featuring the exhaust air duct from FIG. 5 or 7 and the air deflector from FIG. 1.

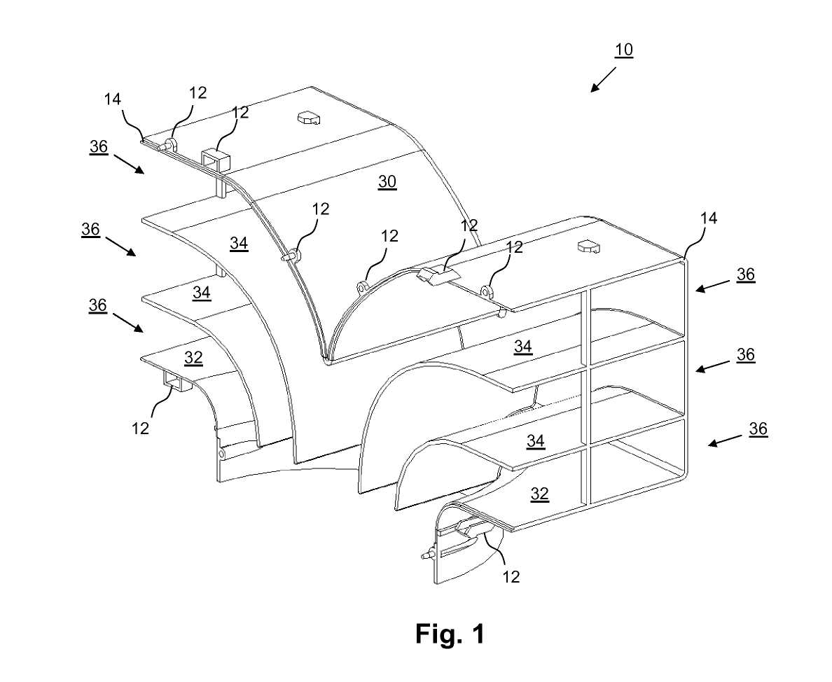

Embodiments, elements or features which are the same or similar in design are provided with identical reference signs in FIGS. 1 though 9.

### BEST WAY OF IMPLEMENTING THE INVENTION

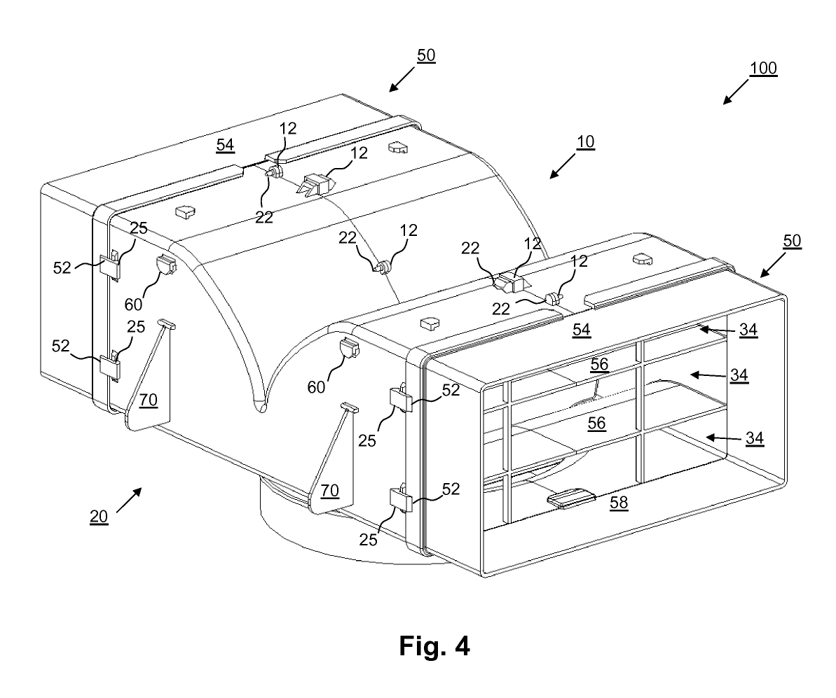

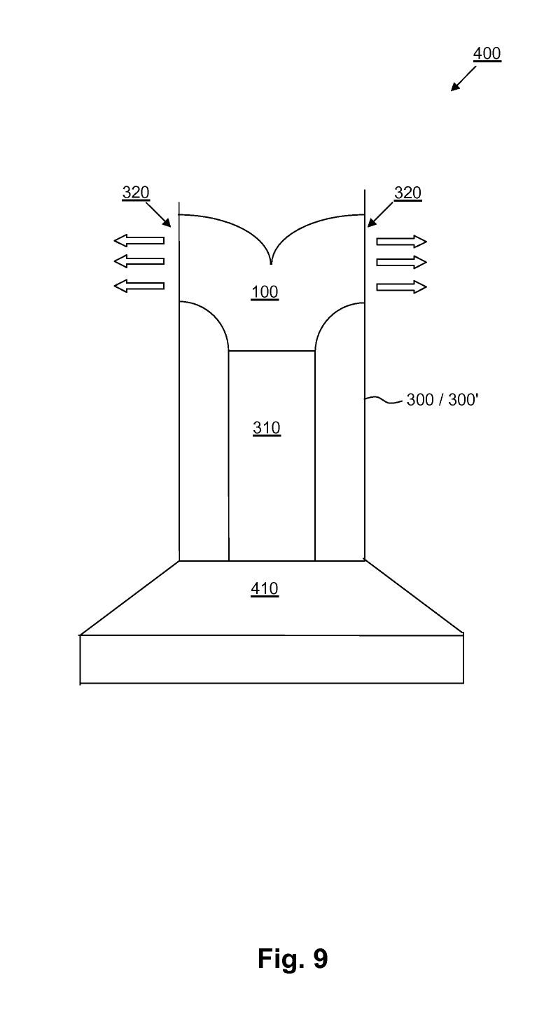

FIG. 1 shows the detailed view of a first component 10 of the exemplary embodiment of the present invention illustrated with reference to FIG. 4. This first component 10 is embodied for diverting the air extracted from a chamber by an extractor hood 400 back into the chamber. In this case, as shown in FIG. 9, the air flow conveyed through an exhaust air duct 300 or 300′, for example through a chimney extractor pipe 310 of the extractor hood 400, is divided up by means of the air deflector 100 and diverted by around 90° in two different directions.

The splitting up and the diversion of the air flow is brought about by the particular constructive design of the air deflector 100. Its components 10, 20 are each delimited on their upper or lower side by an air guide element embodied as a deflector element 30, 32 or 40, 42. Located between the upper and the lower air guide element 30, 32 or 40, 42 are further air guide elements 34 or 44 respectively. In this way a number of deflector channels or air guide channels 36 are formed, by means of which the air flow directed through the chimney exhaust pipe 310 is split up and conveyed to the air outlets 320 of the exhaust air duct or chimney 300.

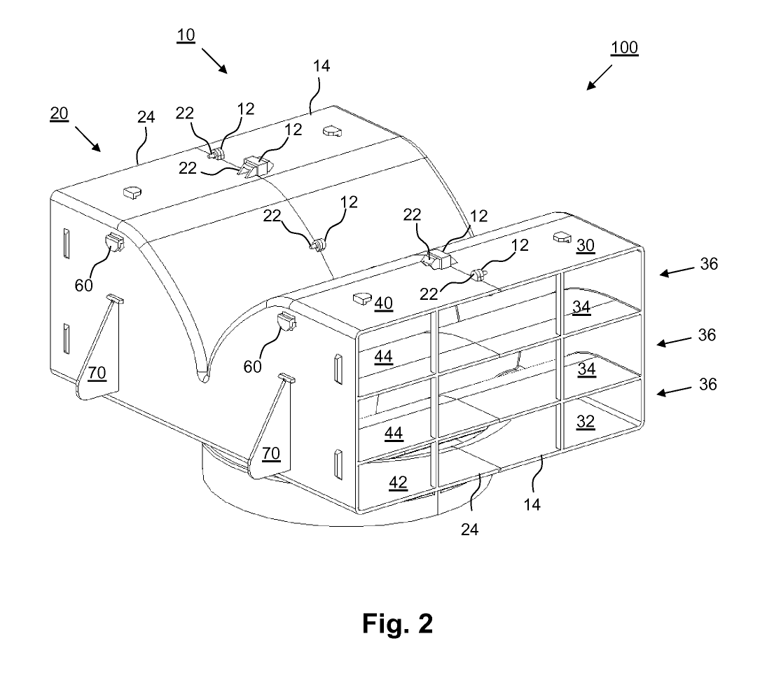

During mounting, or to put it more precisely during assembly of the air deflector 100, the first component 10 is plugged into the further component 20 by means of plug connections 12, 22 and is connected to the said component in a detachable or non-detachable manner, especially latched onto it (cf. FIG. 2). This further component 20 is essentially identical in construction to the first component 10 but is arranged as a mirror image, i.e. rotated by 180 degrees, to the first component 10. The individual elements 12, 22 of the plug connections are embodied in one piece with the air guide elements or housing walls 30, 32 or 40, 42 respectively of the respective components 10, 20.

To adapt the width of the air deflector 100 to the width of the chimney 300, an auxiliary element 50 can be plugged in, preferably on the air outlet side 14, 24 of the air deflector 100 (cf. FIG. 4). This auxiliary element or extension element 50 has plug elements 52 for connecting the auxiliary element 50 to the components 10, 20 of the air deflector 100, which interact with plug elements 25 of the components 10, 20.

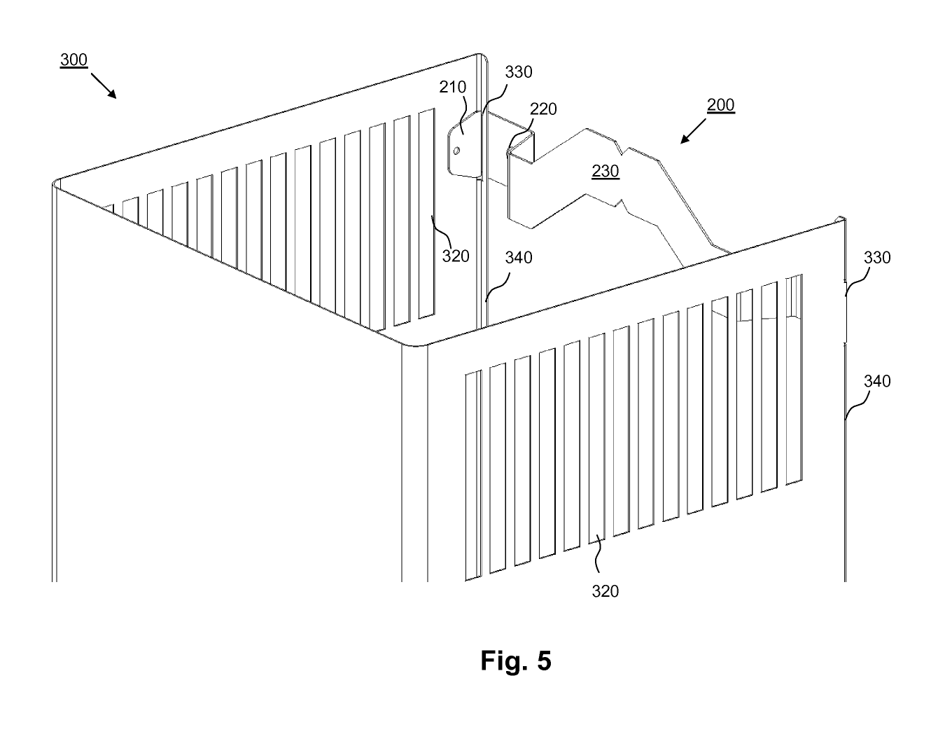

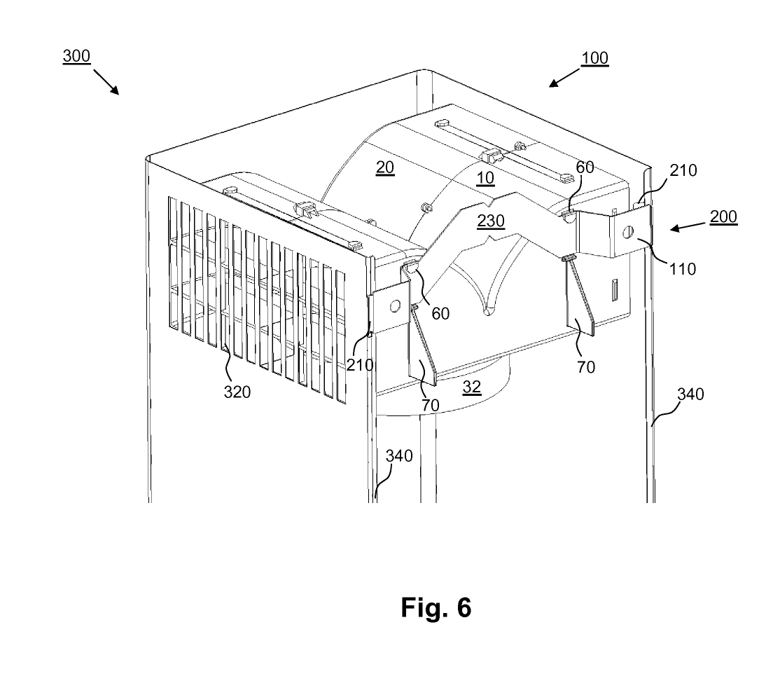

The air deflector 100 can be plugged into or suspended from a mounting bracket shown in FIGS. 5 and 6 by means of retaining elements 60, for example by means of hooks. This mounting bracket 200 can feature at least one recess embodied as a drilled hole 220 for screwing the mounting bracket 200 to a wall not shown in the figure.

In addition to supporting the air deflector 100, the mounting bracket 200 depicted in FIGS. 5 and 6 is also embodied for supporting the chimney 300. For this purpose the mounting bracket 200 has retaining elements 210 which essentially can be pushed in to form an exact fit in recesses 330 arranged on rear wall elements 340 of the chimney 300. This plug connection comprising retaining element 210 and recess 330 thus allows the chimney 300 to the pushed onto the mounting bracket 200 and thereby be attached in a simple manner stably to the mounting bracket 200.

To obtain a predetermined spacing between the air deflector 100 and the wall, the air deflector 100 has spacers 70 on its side facing towards the wall. The spacing of the air deflector 100 from the wall is also achieved by the shape of the mounting bracket 200, especially by an area 230 of the mounting bracket 200 spaced away from the wall.

The chimney 300 depicted in FIGS. 5 and 6 is able to be arranged on a wall and is thus suitable for example as an exhaust air duct for a wall cooker hood.

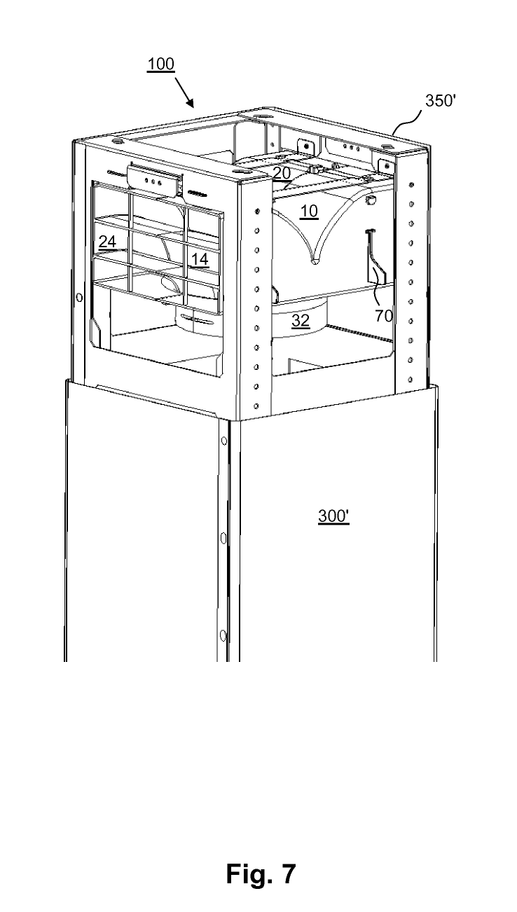

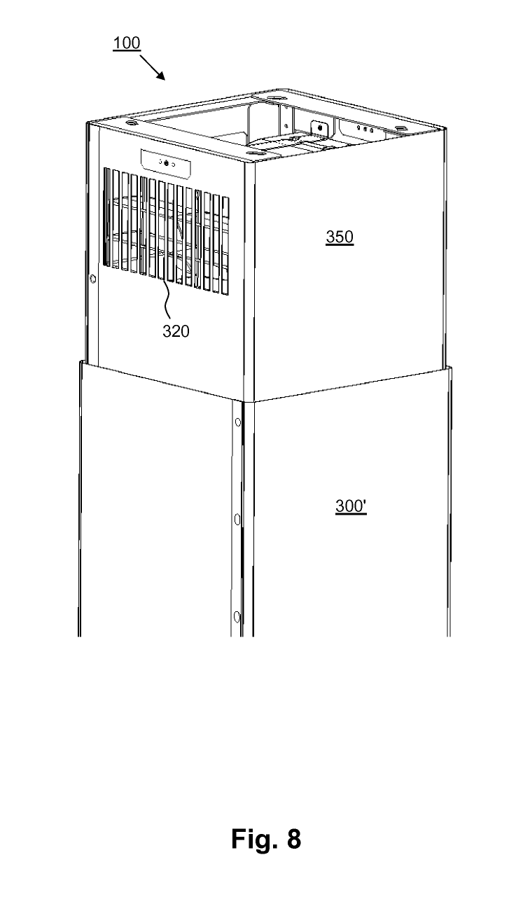

As an alternative the air deflector 100 can also be mounted in an extractor hood arranged freely in a space, for example in an island cooker hood. FIGS. 7 and 8 show the air deflector 100 in a chimney 300′ able to be attached to a ceiling suitable as an exhaust air duct for an island cooker hood. As a supporting element this exhaust air duct 300′ features a tower 350′ lying in the chimney 300′. In the second example of an exhaust air duct shown in FIGS. 7 and 8 the air deflector 100 is thus built into a telescopic or extendable tower 350′ with chimney 300′.

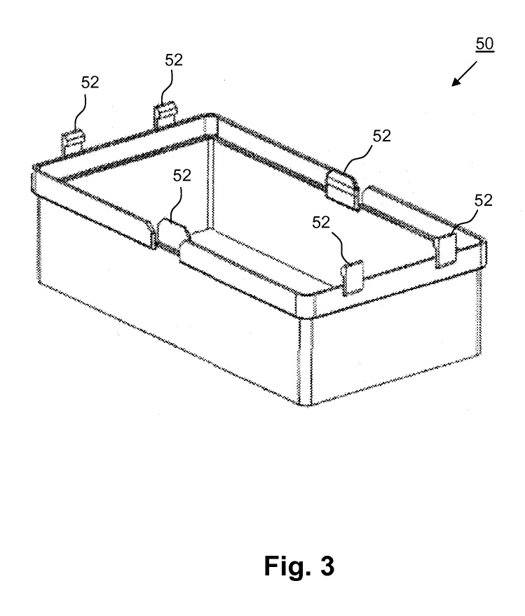

The air deflector 100 shown in FIGS. 1 through 9 differs from the air deflectors known from the prior art especially in its plug connections 12, 22 for detachable or non-detachable connection of the first component 10 and of the further component 20.

Furthermore no air deflector is known from the prior art featuring pluggable extension or auxiliary elements 50 for different widths of chimney.

A further advantageous criterion for distinguishing the deflector from the prior art is the air guide channels 36 which are formed between the first air guide element 30, 40 and/or the second air guide element 32, 42 and/or the further air guide elements 34, 44.

By contrast with the prior art, the air guide elements 30, 40, 32, 42, 34, 44 are preferably substantially made of plastic and can thus be manufactured especially easily and at low-cost.

### LIST OF REFERENCE SIGNS

100 Air deflector
10 First component of the air deflector 100
12 Element of the plug connection arranged on the first component 10 for connecting the first component 10 and the further component 20
14 Air outlet side of the first component 10
20 Further, for example second, component of the air deflector 100
22 Element of the plug connection arranged on the further component 20 for connecting the first component 10 and the further component 20
24 Air outlet side of the further component 20
25 Element of the plug connection arranged on the further component 20 for connecting the auxiliary element 50 and the further component 20
30 First deflector element or air guide element, especially first air guidance plate, for example upper housing wall, of the first component 10
32 Second deflector element or air guide element, especially first air guidance plate, for example lower housing wall, of the first component 10
34 Further deflector element or air guide element, especially further air guidance plate, for example partition wall of the first component 10
36 Air deflector channel or air guide channel for diverting the air extracted by the extractor hood.
40. First deflector element or air guide element, especially first air guidance plate, for example upper housing wall of the second component 20
42 Second deflector element or air guide element, especially first air guidance plate, for example lower housing wall, of the further component 20
44 Further deflector element or air guide element, especially further air guidance plate, for example partition wall, of the further component 20
50 Auxiliary element, especially additional or extension piece embodied as a deflector element, for varying the width of the air deflector 100
52 Element of a plug connection arranged on the auxiliary element 50 for connecting the auxiliary element 50 and the air deflector 100
54 First deflector element or air guide element, especially first air guidance plate, for example upper housing wall of the auxiliary element 50
56 Second deflector element or air guide element, especially second air guidance plate, for example lower housing wall of the auxiliary element 50
58 Further deflector element or air guide element, especially further air guidance plate, for example partition wall, of the auxiliary element 50
60 Retaining element, for example hook element, for suspending the air deflector 100 in or on a mounting bracket 200
70 Spacer for arranging the air deflector 100 at a distance from the wall
200 Mounting bracket, especially for mounting the exhaust air duct 300 and the air deflector 100 on a wall
210 Retaining element of the mounting bracket 200 able to be inserted in the recess 330 of the exhaust air duct 300, especially in the rear wall 340 of the exhaust air duct 300
220 Cutout of the mounting bracket 200 embodied as a drilled hole
230 Area of the mounting bracket 200 spaced away from the wall
300 Exhaust air duct, especially chimney or inner duct of the extractor hood able to be attached to a wall (first exemplary embodiment cf. FIGS. 5 and 6)
300′ Exhaust air duct, especially chimney or inner duct of the extractor hood able to be attached to a ceiling (second exemplary embodiment cf. FIGS. 7 and 8)
310 Extractor pipe of the air outlet duct 300, 300′
320 Air outlet, especially air outlet openings of the air outlet duct 300, 300′
330 Recess of the air outlet duct 300 for receiving the mounting bracket 200
340 Rear wall or rear wall element of the air outlet duct 300
350′ Stabilizing element, especially telescopic tower of the exhaust air duct, able to be arranged in the chimney 300′ (second exemplary embodiment cf. FIGS. 7 and 8)
400 Extractor hood, especially wall cooker hood or island cooker hood with the exhaust air duct 300/300′ and air deflector 100
410 Housing surrounding a suction chamber of the extractor hood 400

1-15. (canceled)

16. An air deflector of an extractor hood, the air deflector comprising:
two components to divert air that is extracted from a chamber by the extractor hood back into the chamber; and
a first plug connector to connect the two components to each other in one of a detachable and non-detachable manner.

17. The air deflector of claim 16, further comprising an auxiliary element to vary a width of the air deflector.

18. The air deflector of claim 17, wherein the air deflector has an air outlet side, and wherein the auxiliary element is placed on the air outlet side of the air deflector.

19. The air deflector of claim 17, further comprising a second plug connector to connect the auxiliary element and the air deflector in one of a detachable and non-detachable manner.

20. The air deflector of claim 19, wherein the air deflector has an air outlet side, and wherein the auxiliary element is placed on the air outlet side of the air deflector.

21. The air deflector of claim 16, further comprising:
a mounting bracket; and
a retaining element to arrange the air deflector on the mounting bracket.

22. The air deflector of claim 21, wherein the retaining element is a hook, and wherein the air deflector is pushed onto the mounting bracket.

23. The air deflector of claim 21, wherein the mounting bracket is configured to attach the air deflector to a wall.

24. The air deflector of claim 23, wherein at least one of:
the air deflector has a rear side facing towards the wall, the rear side having a spacer to arrange the air deflector at a distance from the wall; and
the air deflector is arranged at the distance from the wall due to the shape of the mounting bracket.

25. The air deflector of claim 16, wherein the first plug connector has a latching element to latch assembled elements of the first plug connector together in one of a detachable and non-detachable manner.

26. The air deflector as claimed of claim 16, wherein the two components are substantially identical.

27. The air deflector of claim 16, further comprising a first deflector element to at least one of:
deflect the air extracted by the extractor hood by about 90 degrees; and
divide and divert the air extracted by the extractor hood in two different directions.

28. The air deflector of claim 27, wherein the two directions are opposite directions.

29. The air deflector of claim 27, further comprising a second deflector element, which in conjunction with one of the first deflector element and a further deflector element forms a deflector channel to divert the air extracted by the extractor hood.

30. The air deflector of claim 29,
wherein at least one of the first deflector element, the second deflector element, and the further deflector element are embodied in one piece with the air deflector;
wherein the air deflector has a an upper housing wall, a lower housing wall, and a partition wall; and
wherein at least one of:
the first deflector element forms the upper housing wall of the air deflector;
the second deflector element forms the lower housing wall of the air deflector; and
the further deflector element forms the partition wall of the air deflector.

31. The air deflector of claim 16, wherein the air deflector is essentially made of plastic.

32. A method for mounting an air deflector in an exhaust air duct of an extractor hood, the method comprising:
assembling the air deflector from two components, the two components configured to divert air extracted from a chamber by the extractor hood back into the chamber; and
connecting the two components to each other by at least one plug connector in one of a detachable and a non-detachable manner.

33. The method of claim 32, wherein, in order to match a width of the air deflector to a width of the exhaust air duct, an auxiliary element is arranged on the air deflector.

34. The method of claim 33, wherein the auxiliary element is pushed onto an air outlet side of the air deflector.

35. The method of claim 32, wherein one of:
the air deflector is suspended from a mounting bracket of the exhaust air duct; and
the air deflector is pushed onto the mounting bracket of the exhaust air duct.
